(19) United States
(12) Patent Application Publication
(10) Pub. No.: US 2016/0153371 A1
(43) Pub. Date: Jun. 2, 2016

(54) GAS REGULATOR FOR A MULTI-FUEL ENGINE AND METHOD OF OPERATING SAME

(71) Applicant: Caterpillar Inc., Peoria, IL (US)

(72) Inventor: Xinyu Ge, Peoria, IL (US)

(73) Assignee: Caterpillar Inc., Peoria, IL (US)

(21) Appl. No.: 15/018,892

(22) Filed: Feb. 9, 2016

(51) Int. Cl. F02D 19/06; F02D 41/00

(52) U.S. Cl. CPC F02D 19/0678; F02D 19/0605; F02D 19/0626; F02D 41/0025

(57) ABSTRACT

A gas regulator includes a first sensor adapted to monitor change in gas quality. A regulator valve is adapted to change a first pressure value present at an output of gas regulator. A second sensor is adapted to determine a regulator valve position. An actuator is adapted to change regulator valve position based on a second pressure value which is determined based on at least one of a type of a fuel, gas quality, multi-fuel engine operating conditions, fresh air pressure and temperature, a third pressure value and temperature value of fuels. A third sensor coupled downstream to the gas regulator, and is adapted to measure first pressure value. The gas regulator is in fluid communication with a switch valve which selectively allows at least one of the fuels therethrough. The actuator changes regulator valve position based on a comparison between second pressure value and first pressure value.

### TECHNICAL FIELD

The present disclosure relates to a system for supplying fuel to an engine, and more specifically, to a system for supplying fuel to a multi-fuel engine.

### BACKGROUND

Multi-fuel engine is a type of an engine which runs on multiple fuels such as, but not limited to, gasoline, natural gas, bio gas, or coal gas. The multi-fuel engine is used in various operations such as military operations, and non-military operations. A gaseous fuel, such as a Compressed Natural Gas (CNG) is generally stored in a tank under high pressure, for example, 250-350 bars. Such high pressure of the gas is generally incompatible with an operation of the engine, and impacts Air Fuel Ratio (AFR) control.

Typically, various pressure regulators such as, but not limited to, mechanical pressure regulators, and electronic controlled gas regulators are used for regulating pressure of the fuel supplied to an internal combustion engine for controlling the air fuel ratio. For example, a mechanical pressure regulator regulates pressure only at certain limited range due to pressure drop, but the mechanical pressure regulator fails to adjust pressure according to an engine operating conditions (i.e., an engine speed and an engine load). Similarly, an electronic controlled gas regulator adjusts pressure according to the engine operating conditions (i.e., the engine speed and the engine load) but may not to provide real time control according to a gas quality. Therefore, there is a need for a system to efficiently control the air fuel ratio.

U.S. Pat. No. 8,28,6611, hereinafter referred to as '611 reference, discloses an electronic pressure regulator which serves two functions, i.e., to vaporize liquid propane and to control vapor pressure to a mixer (i.e., carburetor). The electronic pressure regulator monitors and controls the vapor pressure out of the electronic pressure regulator in reference to an inlet air pressure to the carburetor. Moreover, the '611 reference discloses that the electronic pressure regulator controls the delta pressure (i.e., delta P) across the electronic pressure regulator according to different engine operating conditions. However, the electronic pressure regulator fails to adjust its outlet pressure if a gaseous fuel quality is changed. Therefore, there is a need for the electronic pressure regulator to adjust pressure based on the change in the gas quality, and to control the air fuel ratio.

### SUMMARY OF THE DISCLOSURE

An aspect of the present disclosure pertains to an electronic controlled gas regulator. The gas regulator is in fluid communication with a switch valve, and is configured to determine a second pressure value based on at least one of a type of a fuel, gas quality, multi-fuel engine operating conditions, fresh air pressure and temperature, a third pressure value of a plurality of fuels, and a temperature value of the plurality of fuels. The gas regulator includes a first sensor which is adapted to monitor change in the gas quality. A regulator valve is adapted to change a first pressure value present at an output of the gas regulator. A second sensor is adapted to determine a regulator valve position. An actuator is adapted to change the regulator valve position based on the determined second pressure value. A third sensor is coupled to the gas regulator, and is placed downstream of the gas regulator. The third sensor is adapted to measure the first pressure value at the output of the gas regulator. The switch valve is adapted to selectively allow at least one of the plurality of fuels therethrough. The actuator changes the regulator valve position based on a comparison between the first pressure value and the second pressure value.

Other features and aspects of this disclosure will be apparent from the following description and the accompanying drawings.

### BRIEF DESCRIPTION OF THE DRAWINGS

FIG. 1 is a schematic block diagram illustrating a system of a first fumigation configuration for supplying a fuel to a multi-fuel engine, in accordance with the concepts of the present disclosure;

FIG. 2 is a schematic block diagram illustrating a second fumigation configuration for supplying the fuel to the multi-fuel engine, in accordance with the concepts of the present disclosure;

FIG. 3 is a system diagram for a gas regulator which controls pressure of multiple fuels, in accordance with the concepts of the present disclosure; and

FIG. 4 is a flowchart illustrating a method for controlling and supplying the fuel to the multi-fuel engine, in accordance with the concepts of the present disclosure.

### DETAILED DESCRIPTION

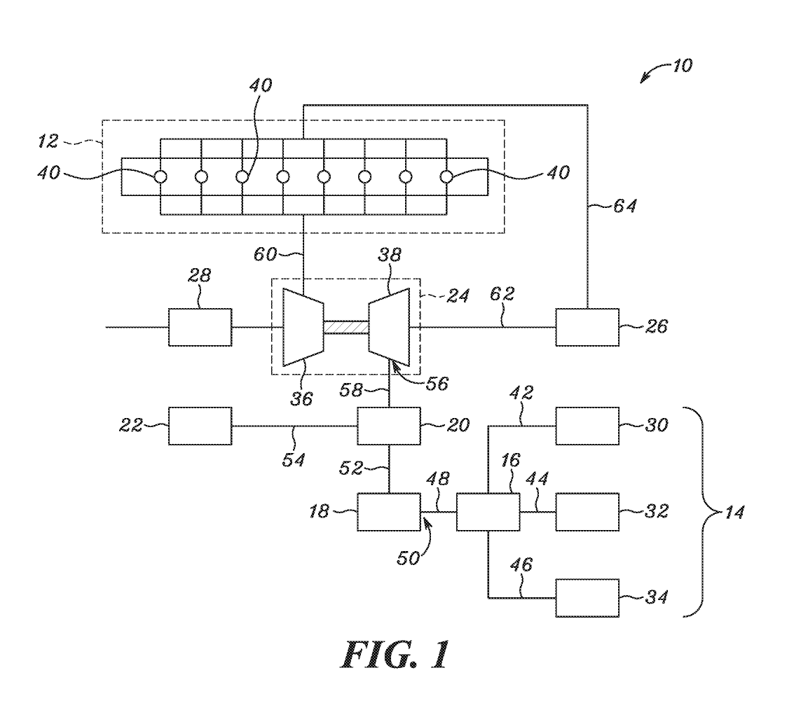

FIG. 1 is a schematic block diagram illustrating a system 10 of a first fumigation configuration for supplying a fuel to a multi-fuel engine 12, in accordance with the concepts of the present disclosure. The system 10 includes the multi-fuel engine 12, a number of fuel sources 14, a switch valve 16, a gas regulator 18, a carburetor 20, a fresh air module 22, a turbocharger system 24, a charge cooler 26, and an aftertreatment system 28. The fuel sources 14 include a first fuel source 30, a second fuel source 32, and a third fuel source 34. The turbocharger system 24 includes a turbine 36 coupled to a compressor 38. Hereinafter, the gas regulator 18 is referred as an electronic gas regulator 18, and the multi-fuel engine 12 is referred as an engine 12. The engine 12 includes multiple cylinders 40. The multiple cylinders 40 include eight cylinders of the engine 12. It should be noted that the eight cylinders of the engine 12 have been provided only for illustration purposes. The engine 12 may include more than eight cylinders or less than eight cylinders as well, without departing from the scope of the disclosure. The engine 12 may be an internal combustion engine, such as a reciprocating piston engine. Further, the engine 12 may be a spark ignition engine or a compression ignition engine.

The system 10 includes the fuel sources 14 (i.e., the first fuel source 30, the second fuel source 32, and the third fuel source 34) which are adapted to supply a number of fuels. For example, the first fuel source 30, the second fuel source 32, and the third fuel source 34, are adapted to supply a compressed natural gas, a liquefied petroleum gas, and a biogas respectively. It will be apparent to one skilled in the art that the fuels (i.e., gaseous fuels) mentioned above have been provided only for illustration purposes. The fuels (i.e., the gaseous fuels) such as coal gas, gasoline etc. are also utilized, without departing from the scope of the disclosure. The fuel sources 14 (i.e., the first fuel source 30, the second fuel source 32, and the third fuel source 34) are fluidly coupled to the switch valve 16 which is placed downstream of the fuel sources 14, by a first fuel conduit 42, a second fuel conduit 44, and a third fuel conduit 46 respectively. Each of the first fuel conduit 42, the second fuel conduit 44, and the third fuel conduit 46, are adapted to receive the fuels at different pressures therethrough. Each of the fuel has a third pressure value T3′ and a temperature value ‘T’. It should be noted that the system 10 may include pressure sensors (not shown) and temperature sensors (not shown) that may be disposed at any location in the fuel sources 14, to measure the third pressure value T3′ and the temperature value ‘T’ of the fuels respectively. Further, the first fuel conduit 42, the second fuel conduit 44, and the third fuel conduit 46, is in form of a pipe, a conduit, a tube, or the like.

Referring to FIG. 1, the switch valve 16 receives the fuels from the fuel sources 14 via the first fuel conduit 42, the second fuel conduit 44, and the third fuel conduit 46. Further, the switch valve 16 is fluidly coupled to the electronic gas regulator 18 which is placed downstream of the switch valve 16. The switch valve 16 is adapted to selectively allow at least one of the fuels to pass to the electronic gas regulator 18 via a first conduit 48. In order to selectively allow at least one of the fuels, the switch valve 16 has three different types of configurations. In a first configuration, the switch valve 16 selects a fuel of the first fuel source 30, and the switch valve 16 then establishes a fluid communication between the first fuel source 30 and an inlet 50 of the electronic gas regulator 18, and blocks the fluid communication between the inlet 50 of the electronic gas regulator 18 and the second fuel source 32 and the third fuel source 34. Similarly, in a second configuration, the switch valve 16 selects a fuel of the second fuel source 32, and the switch valve 16 then establishes a fluid communication between the second fuel source 32 and the inlet 50 of the electronic gas regulator 18, and blocks the fluid communication between the inlet 50 of the electronic gas regulator 18 and the first fuel source 30 and the third fuel source 34. Similarly, in a third configuration, the switch valve 16 selects a fuel of the third fuel source 34, and the switch valve 16 then establishes a fluid communication between the third fuel source 34 and the inlet 50 of the electronic gas regulator 18, and blocks the fluid communication between the inlet 50 of the electronic gas regulator 18 and the first fuel source 30 and the second fuel source 32.

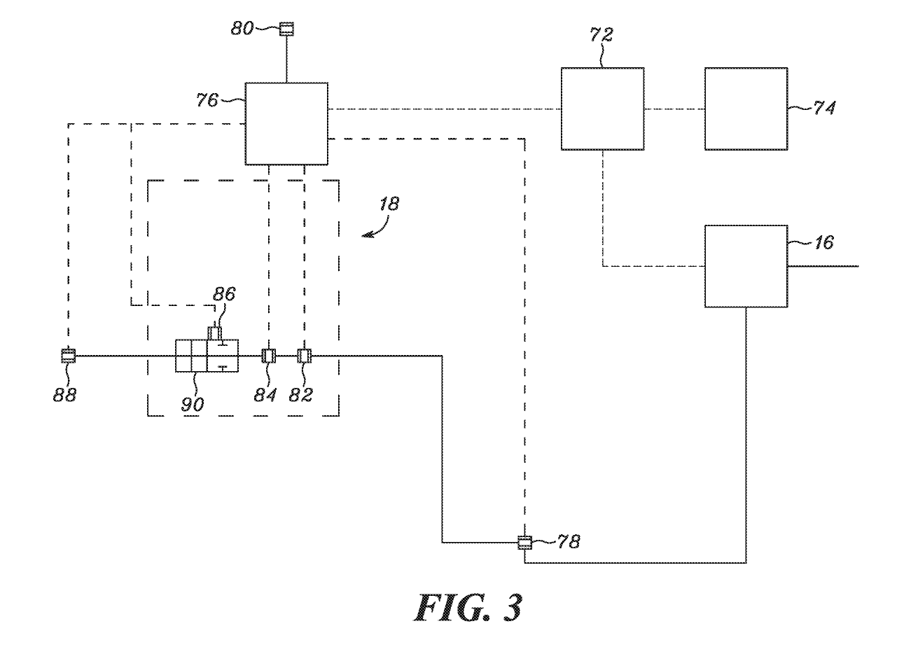

After establishing the fluid communication, the electronic gas regulator 18 is configured to regulate pressure of a fuel supplied from the fuel sources 14 via the switch valve 16. The detailed description of the electronic gas regulator 18 is described later in conjunction with FIG. 3. Thereafter, the fuel is then passed to the carburetor 20 which is placed downstream of the electronic gas regulator 18. The carburetor 20 receives the fuel via a second conduit 52. Further, the carburetor 20 is fluidly coupled to the fresh air module 22 which is adapted to supply fresh air to the carburetor 20 via a third conduit 54. Based on the received fresh air and the fuel, the carburetor 20 then mixes the fuel with the fresh air. Further, the carburetor 20 is fluidly coupled to the compressor 38 of the turbocharger system 24. It should be noted that the carburetor 20 is located at a lower pressure side 56 of the compressor 38.

The compressor 38 receives the fuel mixed with the fresh air, from the carburetor 20 via an intake conduit 58. On the other hand, the turbine 36 is fluidly coupled to the engine 12 via an exhaust gas conduit 60 of the engine 12 such that exhaust gas generated during an operation of the engine 12 is utilized for driving the turbine 36. Further, the aftertreatment system 28 is coupled downstream of the turbine 36, to treat the exhaust gas and hence to control emission of the engine 12. Referring to FIG. 1, the fuel mixed with the fresh air is then passed to the charge cooler 26 which is fluidly coupled downstream to the compressor 38. The charge cooler 26 is adapted to cool the mixture received from the compressor 38 via a fourth conduit 62. After passing through the charge cooler 26, the mixture is then passed to the engine 12 via a fifth conduit 64. It will be apparent to one skilled in the art that the compressor 38 mentioned above may be powered by an external drive member, such as, an electric motor etc., without departing from the scope of the disclosure.

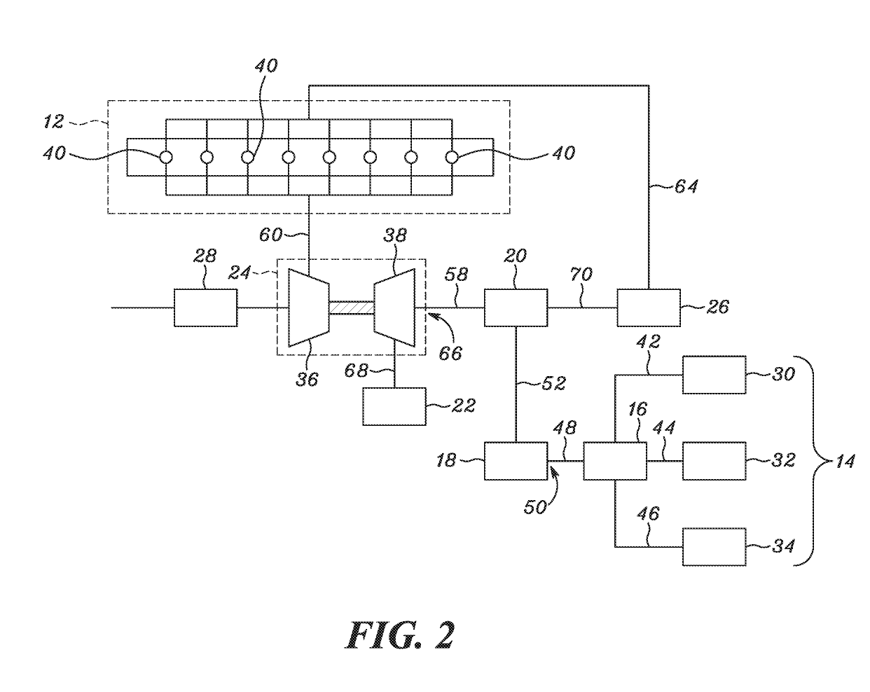

FIG. 2 is a schematic block diagram illustrating a second fumigation configuration for supplying the fuel to the multi-fuel engine 12, in accordance with the concepts of the present disclosure. As discussed above in FIG. 1, each of the first fuel conduit 42, the second fuel conduit 44, and the third fuel conduit 46, is adapted to receive the fuels at different pressures. The fuels are then passed through the switch valve 16 which selectively allows at least one of the fuels to pass to the electronic gas regulator 18 via the first conduit 48. Thereafter, the electronic gas regulator 18 regulates the pressure of the fuel supplied from the fuel sources 14 via the switch valve 16. After passing through the electronic gas regulator 18, the fuel is then passed to the carburetor 20 which is placed downstream of the electronic gas regulator 18.

Further, the carburetor 20, which is placed at a higher pressure side 66 of the compressor 38, is fluidly coupled to the compressor 38 via the conduit 58. The compressor 38 is fluidly coupled to the fresh air module 22 which supplies the fresh air via a sixth conduit 68. The compressor 38 compresses the fresh air to increase a pressure thereof and generate pressurized air. After passing through the compressor 38, the fresh air is then passed to the carburetor 20 via the intake conduit 58. The carburetor 20 mixes the fresh air with the fuel, and is then passed to the charge cooler 26 via a seventh conduit 70. The mixture is cooled when passing through the charge cooler 26, and is then passed to the engine 12 via the fifth conduit 64.

FIG. 3 is a system diagram for the electronic gas regulator 18 for the multi-fuel engine 12, in accordance with the concepts of the present disclosure. The system diagram includes a controller 72, which may a stand-alone controller or an engine ECM (Engine control module) configured to communicate with a first module 74 to obtain various engine operating conditions. The various engine operating conditions include, but not limited to, a desired engine speed, and a desired engine load. The controller 72 further communicates with the switch valve 16 to obtain information related to the type of fuel which is passed to the electronic gas regulator 18. Further, the controller 72 communicates with an electronic regulator controller (i.e., an e-regulator controller) 76.

The e-regulator controller 76 is configured to communicate with a regulator inlet sensor 78 which is placed in between the switch valve 16 and the electronic gas regulator 18. The regulator inlet sensor 78 is adapted to measure the third pressure value T3′ and the temperature value ‘T’ of the fuel. Further, the e-regulator controller 76 communicates with a fresh air sensor 80 which is adapted to measure a pressure value and a temperature value of the fresh air. The e-regulator controller 76 further communicates with various components of the electronic gas regulator 18. The various components of the electronic gas regulator 18 include a first sensor 82, a second sensor 84, and an actuator 86. The e-regulator controller 76 communicates with a third sensor 88 which is adapted to measure a first pressure value T1′ (i.e., a real-time pressure value) at an output of the electronic gas regulator 18. It should be noted that communication lines shown in FIG. 3, between various components such as the controller 72, and the e-regulator controller 76 etc. are shown as connection lines with an inclined double dash. The communication lines include, but not limited to, data buses, fiber optic cables and/or embedded connections.

The first sensor 82 of the electronic gas regulator 18, is adapted to monitor change in gas quality (i.e., a fuel gas quality). The gas quality (i.e., the fuel gas quality) includes, but not limited to, a methane number, and a low heating value (LHV). The first sensor 82 is a gas quality sensor. Further, the electronic gas regulator 18 includes the second sensor 84 which is adapted to determine a regulator valve position. The second sensor 84 is a regulator valve position sensor. The electronic gas regulator 18 further includes the actuator 86 which is adapted to change the regulator valve position based on a second pressure value T2′ (i.e., a desired pressure value). The second pressure value T2′ (i.e., the desired pressure value) is determined based on at least one of the type of the fuel, the gas quality, the engine operating conditions, the fresh air pressure and the temperature, the third pressure value T3′ of the fuels, and the temperature value ‘T’ of the fuels. Further, the electronic gas regulator 18 includes a regulator valve 90 which is adapted to change the first pressure value T1′ (i.e., the real-time pressure value) present at an output of the electronic gas regulator 18. It should be noted that the regulator valve 90 may be one of a poppet valve, a butterfly valve, a ball valve, or a globe valve. As an example, the actuator 86 includes, but not limited to, a proportional controlled solenoid, a torque motor, and a bi-directional stepper motor.

It will be apparent to one skilled in the art that the e-regulator controller 76 mentioned above may be an individual component which is in communication to the electronic gas regulator 18, the actuator 86, the first sensor 82, the second sensor 84, and the controller 72. Alternatively, the e-regulator controller 76 may be integrated within the controller 72 (for example, the engine ECM) as well, without departing from the scope of the disclosure. The controller 72 and/or the e-regulator controller 76 may be a logic unit using any one or more of a processor, a microprocessor, and a microcontroller. The controller 72 and/or the e-regulator controller 76 may be based on an integrated circuitry, discrete components, or a combination of the two. Further, other peripheral circuitry, such as buffers, latches, switches, and the like may be implemented within the controller 72 or separately connected to the controller 72. The controller 72 is also referred as an Engine Control Unit (ECU).

Alternatively, as discussed above in FIG. 1 and FIG. 2, the engine 12 includes the eight cylinders. Each of the eight cylinders of the engine 12 mentioned above may be provided with a gas admission valve (not shown) for supplying fuel to the multiple cylinders 40. Further, the engine 12 is used to provide power to any machine such as, but not limited to, an on-highway vehicle, an off-highway vehicle, an earth moving machine, and an electric generator. The engine 12 may be associated with any industry including, but not limited to, transportation, construction, agriculture, forestry, power generation, and material handling. The engine 12 may also include various systems such as, intake system, an exhaust system, a cooling system, and a drivetrain.

### INDUSTRIAL APPLICABILITY

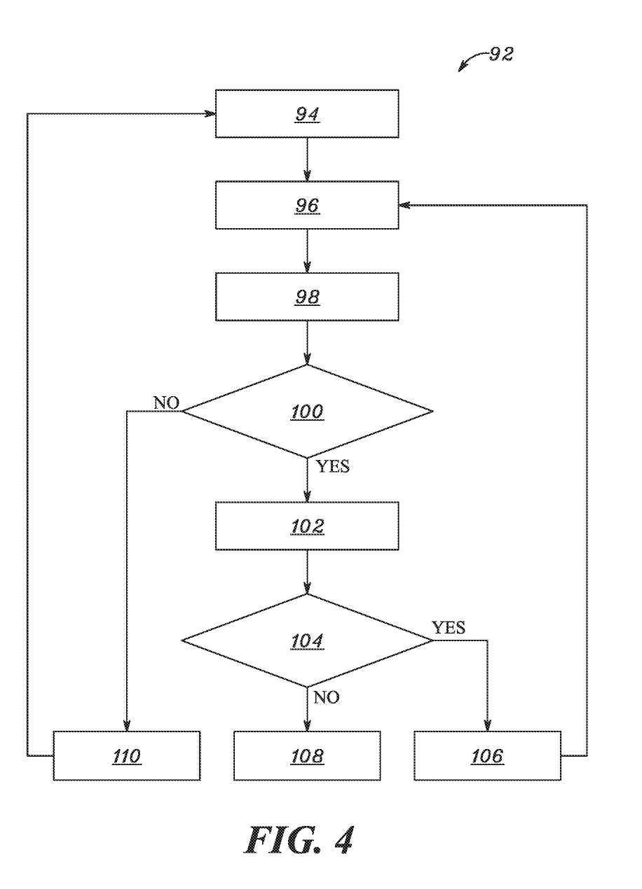

FIG. 4 is a flowchart illustrating a method 92 for controlling and supplying the fuel to the multi-fuel engine 12, in accordance with the concepts of the present disclosure. The method 92 is described in conjunction with FIGS. 1, 2, and 3.

At step 94, the controller 72 (i.e., the engine ECM) determines the second pressure value T2′ (i.e., the desired pressure value) based on at least one of the type of the fuel, the engine operating conditions, the fresh air pressure and temperature, the third pressure value T3′ of the fuel, and the temperature value ‘T’ of the fuel. Prior to determining the second pressure value T2′ (i.e., the desired pressure value), the controller 72 (i.e., the engine ECM) communicates with the switch valve 16, the first module 74, and the e-regulator controller 76, to obtain information related to the type of the fuel, the engine operating conditions, the fresh air pressure and the temperature, and the third pressure value T3′ and the temperature value ‘T’ of the fuel respectively. Thereafter, the controller 72 (i.e., the engine ECM) determines the second pressure value T2′ (i.e., the desired pressure value).

Further, in a scenario, if the switch valve 16 switches among the fuel sources 14 (i.e., the switch valve 16 switch fuels), then the controller 72 (i.e., the engine ECM) adjusts the second pressure value T2′ (i.e., the desired pressure value).

At step 96, a pressure error is determined based on a comparison. The comparison is performed by the e-regulator controller 76 between the second pressure value T2′ (i.e., the desired pressure value) and the first pressure value T1′ (i.e., the real-time pressure value). The second pressure value T2′ (i.e., the desired pressure value) is determined above in step 94. On the other hand, the first pressure value T1′ (i.e., the real-time pressure value) is determined by the third sensor 88 placed at the output of the electronic gas regulator 18. After determining the pressure error, the e-regulator controller 76 (shown in FIG. 3) locates valve position from a lookup or an estimation model, and then sends adjustment signals to the actuator 86 of the electronic gas regulator 18.

At step 98, the actuator 86 of the electronic gas regulator 18 changes the regulator valve position based on the determined pressure error. As discussed above, the pressure error is determined based on the comparison between the second pressure value T2′ (i.e., the desired pressure value) and the first pressure value T1′ (i.e., the real-time pressure value). The actuator 86 adjusts the regulator valve position in order to bring the first pressure value T1′ (i.e., the real-time pressure value) close to the second pressure value T2′ (i.e., the desired pressure value T2′) with the help of values measured by the second sensor 84 and the third sensor 88.

At step 100, it is checked whether the engine 12 runs at steady-state condition. If the engine 12 runs at the steady-state condition (answer is “Yes”), the method 92 goes to step 102. Otherwise, the method 92 goes to the step 110.

At step 102, the first sensor 82 of the electronic gas regulator 18 measures the gas quality (i.e., the fuel gas quality). As discussed above, the gas quality includes, but not limited to, the methane number and low heating value (LHV).

At step 104, it is checked whether the gas quality is changed. The change in the gas quality is determined based at least on a first condition and a second condition. The first condition is to compare a difference between the methane number at a time ‘T1’ and ‘T2’ to a predetermined threshold. Similarly, the second condition is to compare a difference between the low heating value (LHV) at the time ‘T1’ and ‘T2’ to the predetermined threshold. If the difference between the methane number at a time ‘T1’ and ‘T2’ is greater than predetermined threshold, and/or the difference between the low heating value (LHV) at the time ‘T1’ and ‘T2’ is greater than the predetermined threshold (answer is “Yes”), the method 92 goes to the step 106. Otherwise, the method 92 goes to the step 108.

At step 106, the second pressure value T2′ offset is calculated based on the change in the gas quality, and thereafter, the method 92 goes to the step 96. The change in the gas quality is determined based on the change in the Methane number and Low heating value (LHV), as discussed above.

At step 108, the second pressure value T2′ (i.e., the desired pressure value) is retained. At step 110, the engine operating conditions are monitored by the controller 72 (i.e., the engine ECM), and thereafter, the method 92 goes to the step 94. As discussed above, the engine operating conditions include, but not limited to, the desired engine speed and the desired engine load.

When the engine 12 runs on multiple fuels, the difference among fuels often requires corresponding changes in the associated subsystems and calibration maps to ensure the consistent performance. It is cost effective to keep the high level engine ECM and calibration map in common at different operating conditions. The electronic gas regulator 18 may adjust the second pressure value T2′ according to the first sensor 82 (i.e., the gas quality sensor). The adaptive adjustment allows the engine 12 to use the same calibration map, and hence reduces the develop cost and saves the deployment time.

The present disclosure provides the electronic gas regulator 18 for controlling and supplying the fuel to the multi-fuel engine 12. The electronic gas regulator 18 discloses the first sensor 82 which is adapted to monitor change in the gas quality, the second sensor 84 which is adapted to determine the regulator valve position, and the actuator 86 which changes the regulator valve position based on the comparison between the second pressure value T2′ (i.e., the desired pressure value) and the first pressure value T1′ (i.e., the real-time pressure value). Further, the regulator valve 90 is adapted to change the first pressure value T1′ (i.e., the real-time pressure value) at the output of the electronic gas regulator 18. The third sensor 88 is adapted to measure the first pressure value T1′ (i.e., the real-time pressure value) at the output of the electronic gas regulator 18. Such type of the electronic gas regulator 18 regulates the pressure based on the type of the fuel, the gas quality, the engine operating conditions, the third pressure value T3′ of the fuel, and the temperature value ‘T’ of the fuel, and thus results in efficiently controlling air fuel ratio.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A gas regulator for controlling and supplying fuel to a multi-fuel engine, the gas regulator comprising:
a first sensor adapted to monitor change in gas quality;
a regulator valve adapted to change a first pressure value present at an output of the gas regulator;
a second sensor adapted to determine a regulator valve position; and
an actuator adapted to change the regulator valve position based on a second pressure value, wherein the second pressure value is determined, by the gas regulator, based on at least one of a type of a fuel, the gas quality, the multi-fuel engine operating conditions, fresh air pressure and temperature, a third pressure value of plurality of fuels, and a temperature value of the plurality of fuels;
wherein the gas regulator is coupled downstream to a third sensor, the third sensor is adapted to measure the first pressure value at the output of the gas regulator, and the gas regulator is in fluid communication with a switch valve that selectively allows at least one of the plurality of fuels therethrough;
wherein the actuator changes the regulator valve position based on a comparison between the first pressure value and the second pressure value.
